(19) United States
(12) Patent Application Publication
(10) Pub. No.: US 2018/0006421 A1
(43) Pub. Date: Jan. 4, 2018

(54) Methods for Disrupting Tornadic Activity

(71) Applicant: R. Joe Planson, Mountain Brook, AL (US)

(72) Inventor: R. Joe Planson, Mountain Brook, AL (US)

(21) Appl. No.: 14/146,212

(22) Filed: Jan. 2, 2014

(51) Int. Cl. H01S 3/00; F41H 13/00; A01G 15/00

(52) U.S. Cl. CPC H01S 3/0007; F41H 13/005; A01G 15/00

(57) ABSTRACT

Intensity increases in tornadoes result from electrical and magnetic conditions from cloud rotation that establish the appropriate environment for electromagnetic induction of conductive materials to heat energy. The means of slowing down or stopping a tornado begins by first predicting an area of possible tornadic activity. The path of said tornado must also be anticipated to determine the firing location of a laser or release of chemical agents. The laser and/or chemicals must be fired or dispersed ahead of the tornado to subdue the storm. Ideally, the laser will be fired in the direct path of the tornado with a lead time of at least thirty minutes.

### METHODS

### Field of Invention

The field of the invention is methods for injury and damage prevention to people and property specifically by disrupting or dissipating tornadic, or cyclone, activity.

### Background of invention

Natural disasters are a rare blend mesmerizing power and destruction. Man has spent countless hours and resources studying, observing, and researching natural disaster to gain a better understanding of the destructive forces of our world. While many questions are being answered and preventative measures being taken to protect lives and property, tornadoes remain a natural occurrence that are not fully understood and wreak havoc on innocent people. The awful destructive power of tornadoes has been measured through the years in United States through property damage and loss, bodily harm, and in many cases death without significant progress in the prediction, tracking, prevention or early warning of oncoming tornadoes to those in harm's way.

Unlike its destructive relative, the hurricane, scientists have been relatively unsuccessful in developing methods to protect people and property from tornadoes, or at least, warning bystanders of the imminent threat of the powerful tornadoes/cyclones. This is, in large part, due to a lack of understanding of tornadoes; particularly the mechanism by which they increase and decrease intensity. According to the National Ocean and Atmospheric Administration (NOAA), the average early alert time for tornadoes in the United States is a scant 13 minutes, barely enough time for those in danger to seek shelter in their own homes. With a yearly average of 1,253 tornadoes occurring each year, a lack of preventative measures leads to an average of 109 fatalities and an alarming $27.3 billion in property damage in 2011 alone. These staggering numbers call for better early alert systems and preventative measures.

While current theories detail the necessary conditions for tornadogenesis, many lack an understanding of the mechanism that drives tornado intensification once it has been formed—electromagnetic induction (EMI). When warm, moist air from the Gulf of Mexico and cool, dry air from the northwest interact, a violent reaction occurs with warm air surging upwards and cooler air falling. This produces strong rotating winds, lightning and results in the proper conditions for tornado formation. Rapidly rising warm air, called updraft, can result in the tilting of horizontal rotation in the atmosphere to create wind shear and vertical rotation. As this vertical rotation descends to the earth, a tornado is born. The movement of electrons (conductive materials) in a variable magnetic field results in electromagnetic induction heating—the force that drives tornado intensification. This movement of electrons induces electrical energy to the heat energy needed to drive the storm.

Loss of EMI heat energy inputs, ionized gases, and cold air infusion result in death of the tornado. Conductive materials that are heated, giving up their heat energy to the surroundings by conduction and convection due to fast air rotation, will maintain their conductivity and be electromagnetically induced until they are expelled by centrifugal forces from the funnel area. However, fallout loss of conductive materials by centrifugal forces with time may also reduce heating. Disturbances in the atmosphere create charged particles that accumulate in clouds, resulting in an electric field. When charges in this electric field build up and a connection is established an electric discharge results in the form of lightning. When these electric charge fields begin rotating due to the vertical shear winds of a tornado, a magnetic field is created. This electromagnetic field, thus, becomes a defining characteristic of tornado intensity increases and, through induction, the mechanism which determines tornado intensity and life cycle. Electromagnetic induction needs fuel to drive the process.

This fuel is found in the form of conductive materials which can be defined as anything that carries an electrical charge that can drive the tornado. When storms discharge electrical energy through lightning, the large amounts of energy released results in the breaking of chemical bonds holding atmospheric particles together, in turn, creating more available charged particles to fuel the tornado. In effect, lightning strikes create more fuel to feed the electromagnetic process that helps drive a tornado. This is seen in NOₓ conversion and ozone reactions leading to the ionization of highly conductive nitrogen (N) and oxygen (O) ions among other ionized gases. Consumption (chemical conversion from ionized to non-ionized gases) of ionized gases takes away inducible food in the immediate storm system and with little to no conductive material input in rural areas and lower lightning bolt levels from electromagnetic induction conversion areas, the tornado energy levels fade. Gravity waves can also have a great influence on tornado intensification as they distort magnetic fields, increase wind speeds and cause irregular movement of electrons in a magnetic field that are electromagnetically induced.

Increasing the conductivity of the system allows electricity to flow more freely. Electrical energy is then thermodynamically converted to heat energy and heat transferred by fast moving winds in a tornado. Tornadoes sometimes get electrically disconnected from the shelf cloud ionized gases and a conductive material and, as a result, lose the conductive food source in the immediate surrounding area, also resulting in tornado death. However, sometimes the shelf cloud reforms a new tornado system or tornado systems later because the electromagnetic energy and ionized gases are still being produced downstream by lightning bursts.

Current theories are correct in observing that tornadoes follow warm air in an attempt to feed the system, however, this is due to the fact that warmer air contain more charged particles, the real energy source for tornadoes. While current research focuses on the detection and warning against tornadoes, this improved understanding of the driving force behind tornadoes leads to an effort to prevent, stop or, in the least, weaken these violent storms to protect the property and lives of Americans. Historically, tornadoes occur in specific areas in the United States and around the world. Using historically available data provides the ability to focus efforts and preventative measures on areas of high tornado activity.

Past inventions designed to prevent or weaken tornadoes have fallen short due to a lack of understanding of the driving forces behind tornadoes. Attempts to mechanically reverse wind rotation in tornadoes have proven ineffective due to the sheer power of tornado systems. Attempts to disperse chemical agents into the air such as silver iodide or super-cooled compounds have also yielded inconclusive results and may, in fact, create more conductive materials to fuel the storm. This is in part due to dumping of said chemical agents into and above the tornadoes whereas, the fuel that drives tornadoes comes from in front of the tornado.

Essentially, no effective means to quell the fury of a tornado have been discovered. The statistics show there is a grave need in this country to not only improve tracking and prediction capabilities, but, also, create ways to tame these natural disasters. Moving forward any future inventions must not only be effective in destroying or weakening tornadoes, but, also, must be at the ready on short notice, cost effective, safe to individuals and leave no residual damage to the environment. The following method for disrupting tornadic activity meets these needs.

### SUMMARY OF PRESENT INVENTION

The present invention is defined by the following claims and nothing in this section should be understood as a limitation on said claims.

The invention describes and claims methods of disrupting tornadic activity by dissipation, precipitating, or thereby reducing conductive materials to fuel the tornado. The first step is to predict an area of tornadic activity and subsequently determine the path of said tornado using historical data. Once a path is determined, the first method is shooting a laser into the sky ahead of the tornado to spark lightning discharges in order to remove available conductive materials from the system, thereby, reducing the intensity of the storm. The preferred laser should emit ultraviolet (UV) laser pulses. Lasers should be discharged at least thirty minutes ahead and not into the tornado as suggested by others, as this would only fuel the storm. Firing lasers well ahead of the storm system will dissipate electrical energy in the clouds around the storm area over time; thereby, reducing electrical energy and charged materials available in the surrounding environment of the storm system.

In preferred embodiments of the laser discharge method, lasers are mounted to vehicles driven in front of the storm, on a remotely operated airplane (drone), mounted to the ground in areas with a history of high tornado activity, or shot from satellites orbiting the Earth at precise locations. One manner in which lasers may be stationed in ground areas is a grid pattern where lasers are placed in specific locations based on historical data of tornado paths to maximize the potential for disrupting the storm.

Another preferred method involves releasing chemical agents into the path of the tornado that precipitate or thereby reduce conductive materials in the path of the tornado. These chemical agents will bond with the ionized form of atmospheric gases including nitrogen, oxygen, carbon dioxide and any other trace compounds to deionize said gases.

In preferred embodiments of the chemical agent dispersal method, chemicals are dispersed ahead of the tornado path by airplane. In one embodiment, the airplane may release said chemicals from a reservoir directly into the atmosphere. Another option would be to release chemicals from the plane in containers that can be remotely opened during descent at the optimal time and height. Alternatively, chemical agents can be launched into the atmosphere via missiles or other like devices, either mounted on vehicles or at stationary locations in areas of historically high tornado activity.

It is critical to attack tornadoes in the earliest stages of formation as possible. Allowing tornadoes to become larger and more violent only decreases the chances of disrupting their activity. If not attacked early enough, some powerful tornadoes may become too strong to effectively disrupt. The tornado may pick up conductive materials on the ground in its path. Improved understanding of tornado formation and movement will allow scientist to better predict tornadoes and build models to predict their paths. Better early alert times will give more people the opportunity to prepare for tornadoes and will increases the chances of success of the present methods.

### DETAILED DESCRIPTION OF HOW IT WILL BE USED

The present invention is a method to disrupt, reduce intensity or effectively stop tornadoes. The method focuses on depleting the surrounding energy sources (conductive materials in the form of ionized gases) from the atmosphere, thereby, killing the tornado.

The term tornado, or cyclone, is used to describe a funnel-like column of rotating air occurring naturally and often associated with other storms. The funnel-like column often descends from a storm or mesocyclone and travels across open ground. However, the term “tornado” can also refer to a waterspout, fire wheel, fire tornado, dust devils, or any other natural occurrences operating as a free-moving, vertical column of rotating air.

As previously described, tornadoes are devastating natural occurrences that form by joining of cold and warm air fronts and rotating air columns that form thereafter by wind shear or other means in nature. Tornado intensity increases are driven, or powered, however, by electromagnetic forces resulting from moving electrical charges in a magnetic field resulting in EMI. This electromagnetic system seeks out charged particles in the air from ionized gases to fuel the system. According to NASA, these charged particles have an average half-life of thirty minutes so the tornado must follow the path of lightning and warm air fronts to replenish its supply of fuel. Triggering lightning well ahead of the storm gives these ionized gases time to be converted to a non-ionized state and, as such, are no longer available as an energy source for the tornado. When the tornado is unable to fuel the system with conductive materials, it begins to slow down and eventually die off. This process may take minutes to a few hours depending on environmental factors and conditions such as lightning.

The methods of this invention focus on the reduction of conductive materials in and around the tornado to effectively “strangle” the system by depleting the energy source. This can be accomplished by 1) strategically firing lasers in front of the tornado to ionize and, in turn, deionize atmospheric gases well ahead of the storm to limit the supply of conductive materials and 2) introducing chemical agents into the atmosphere to bond with said atmospheric gases to limit the supply of available conductive materials.

First, as electromagnetic storms, tornadoes seek the path of least resistance (highly conductive environments and strong magnetic fields), similarly to current in an electrical circuit. This path is determined by the amount of available conductive materials in the surrounding area that can be consumed by the tornado. In essence, the tornado seeks out the energy to feed the system—the path of least resistance. Removing these conductive materials disrupts the balance and power consumption of the storm; thereby, effectively killing the storm. Strategically removing conductive materials from the atmosphere can also reroute a tornado to a location away from innocent civilians and property to a place where said tornado can die down peacefully and without further damage. Thus, even if the present method does not completely disturb and terminate a tornado, the ability to control the path of a tornado and/or weaken it can still save countless lives and costs in property damage. In addition, the reduction of conductive materials in the area surrounding a storm can reduce the chances of additional tornado formation for the duration of said storm.

The first step of the preferred embodiment of the present methods requires locating a storm capable of producing a tornado. While meteorologists may not be able to accurately predict tornadoes, they are able to track storms that possess all the components for possible tornadic activity. By tracking storms and identifying possible areas of tornadic activity, scientists and officials can get ahead of the development of tornadoes by depleting conductive materials in the area surrounding the storm before a tornado even touches ground; thereby, reducing or even preventing the chances of a storm even birthing a tornado. An area of tornadic activity can be defined as an area where tornadoes are likely, or have already, occurred.

The term laser refers to a focused beam of light that can travel great distances without decreased collimation. In the present method, a specific laser is used based on past research by Khan et. al published in 2002. Research suggest that the ultraviolet (UV) laser pulses are the appropriate means for laser-induced lightning discharge. According to the research,
UV (220-420 nm) 200 ps laser pulses with a peak power of around 50 MW (or 12.5) mJ input energy) and a beam size of 100 μm are the optimal tool to trigger outdoor lightning. The laser beam size remains relatively small (less than 0.3 mm) after a propagation distance of 200 m up into the normally cloudy and damp atmospheric conditions.

In preferred embodiments of the present method, the optimal laser is discharged in areas of likely, or ongoing tornadic activity to prevent or disrupt tornadoes. Lasers can potentially be discharged by ground sites located in strategic areas of historically high tornadic activity, by vehicle or plane carrying the lasers to sites of tornadic activity in the path of the storm, by remotely piloted drone, satellite or other delivery method.

The lasers will be discharged in the predicted path of the storm to remove conductive materials and ahead of the storm and, in effect, disable the funnel. The laser must be discharged far enough ahead of the storm for the resulting lightning to ionize the air and for atmospheric gases to return to a non-ionized state. If there is not enough lead time for deionization to occur then laser discharges only feed the tornado. However, if laser discharges occur too far ahead of the tornado, there will be time for the air to deionize and again ionize before the tornado arrives. Ionized atmospheric gases have a half-life of approximately 30 minutes. Therefore, lasers would trigger lightning approximately forty five minutes ahead of the storm to give atmospheric gases time to deionize but not enough time to again ionize ahead of the tornado.

In the chemical agent dispersal method, chemical would ideally be released by a remotely piloted drone ahead of the path or the tornado by any methods of deionizing conductive materials. This will reduce the risk of injury for pilots or other individuals that would have otherwise been tasked with dispersion of the chemicals. In the preferred embodiment of the present method, polonium 210 could be used to remove charged materials from the atmosphere. Polonium 210 is a radioactive element found in small quantities in the environment. It can also be synthesized in a laboratory environment. Today, polonium 210 is used to remove static electricity in machinery and to provide “clean rooms” by neutralizing charges in the surrounding atmosphere. It is hazardous to humans only when taken into the body but is subject to no IAEA safeguards. Therefore, for the purposes of this method, polonium 210 is safe to humans and the environment.

Polonium 210 is an alpha-emitter that collides with air molecules. Each time an alpha particle strikes an air molecule they ionize said molecule and lose energy with each collision. Each alpha particle only travels a few centimeters before it stops; however, it creates hundreds of thousands of ion pairs along its path. The alpha particle then picks up two electrons to form a helium atom and drifts away into the atmosphere. This process removes charged particles from the surrounding atmosphere, effectively neutralizing any charge in the surrounding area. This is ideal for suppressing tornado activity by removing the conductive material energy source needed to fuel the storm. Because the alpha particles only travel a few centimeters, they are of no health concern to any individuals in the region of dispersal and the end result is helium atoms that yield no toxic effects on the environment.

In the first embodiment of the polonium 210 dispersion method, the chemical would be releasable contain in either one or multiple containers on board the drone or attached externally to the plane or drone. The chemical is either dispersed into the atmosphere or dropped from the canisters to be released into the atmosphere at a designated time and altitude. For example, the chemical may be released from containers in the same fashion that a farmer releases chemicals on his fields via a crop duster airplane. In this embodiment, the chemical would be released ahead of the storm by either a single, or multiple, drone(s) at the appropriate altitude to maximize the removal of charged particles available to fuel the storm.

In the second embodiment, the chemical would be released in containers from the plane or drone at the appropriate time ahead of the tornado. Containers could be affixed with an altimeter or remotely detonated to trigger release of the chemical at the designated height. Alternatively, containers may be shaped and formed in the fashion of present bomb designs and may, in fact, be chemical bombs of existing design. Containers may also be smart bombs or missiles that can be guided to precise location to be detonated at remote locations. Desirable altitudes for the release of the chemical would be near cloud formations. This is the area of highest charged particle concentration, so chemical dispersion would be the most effective here.

The particular embodiments described above are strictly illustrating and should in no way be considered as restrictive upon the invention. It is to be understood also that modifications and changes to the invention may be devised by those skilled in the field of the invention and fall within the scope thereof. It is not desired to limit the invention to the above constraints. The invention is defined by the following claims and all variations that fall within the claims are intended to be accepted therein.

I claim:

1. A method of disrupting tornadic activity by preventing or reducing an electrical connection of the electrical helical coil of an impending storm (of any type including a tornado) or creating an electrical disconnect in an existing storm through any available means, wherein altering, controlling or manipulating lightning activity in or around the storm achieves said electrical disconnect or any portion thereof.

2. A method of disrupting tornadic activity by preventing or reducing an electrical connection of the electrical helical coil of an impending storm (of any type including a tornado) or creating an electrical disconnect in an existing storm through any available means, wherein magnetic fields characteristic of the storm are altered, controlled or manipulated.

3. A method of disrupting tornadic activity by preventing or reducing an electrical connection of the electrical helical coil of an impending storm (of any type including a tornado) or creating an electrical disconnect in an existing storm through any available means, where rotation is maintained by electromagnetic forces and the consumption of conductive materials (i.e. charged particles) in the area within or surrounding the tornado at different altitudes, comprising the steps of:
a. Locating an area conducive to or containing ongoing tornadic activity; wherein the area comprises a storm, including mesocyclones, or conditions for a storm that contains the appropriate environmental conditions for the formation of a tornado,
b. Discharging lasers in the area well ahead of potential or ongoing tornadic activity,
c. Wherein the laser is discharged at least thirty (30) minutes ahead of the storm or tornado to ionize atmospheric gases; giving them time to deionize by natural chemical reactions,
d. Wherein discharging of the laser produces lightning strikes ahead of the storm which result in a loss of available conductive materials for tornado formation and/or continuation,
e. Wherein the laser discharged ahead of the storm is located in fixed positions on the ground,
f. Wherein the locations for ground lasers are based on areas of historically high tornadic activity, Wherein the area of possible or ongoing tornadic activity is comprising of:
a storm, including mesocyclones, that contains the appropriate level of environmental conditions for tornado formation,
Wherein the laser is discharged at least thirty (30) minutes ahead of the storm or tornado,
Wherein discharging the laser produces lightning strikes ahead of the storm which result in a loss of available conductive gases or materials for tornado formation and/or continuation,
g. Wherein the laser discharged ahead of the storm is mounted to a storm chasing vehicle to be discharged by those operating the vehicle,
Wherein the area of possible or ongoing tornadic activity is comprising of:
a storm (including mesocyclones) that contains the appropriate level of environmental conditions for tornado formation,
Wherein the laser is discharged at least thirty (30) minutes ahead of the storm or tornado,
Wherein discharging the laser produces lightning strikes ahead of the storm which result in a loss of available conductive gases or materials for tornado formation and/or continuation,
h. Wherein the laser discharged ahead of the storm is mounted to a storm chasing vehicle to be discharged by those operating the vehicle,
Wherein the area of possible or ongoing tornadic activity is comprising of:
a storm (including mesocyclones) that contains the appropriate level of environmental conditions for tornado formation,
Wherein the laser is discharged at least thirty (30) minutes ahead of the storm or tornado,
Wherein discharging the laser produces lightning strikes ahead of the storm which result in a loss of available conductive materials for tornado formation and/or continuation,
i. Wherein the laser discharged ahead of the storm is mounted to a remotely operated airplane (drone) to be detonated ahead of the storm by the drone operator,
Wherein the laser is discharged at least thirty (30) minutes ahead of the storm or tornado,
Wherein discharging the laser produces lightning strikes ahead of the storm which result in a loss of available conductive materials for tornado formation and/or continuation,
j. Wherein the laser discharged ahead of the storm is fired from a satellite in orbit of the earth,
Wherein the area of possible or ongoing tornadic activity is comprising of:
a storm, including mesocyclones, that contains the appropriate level of environmental conditions for tornado formation,

4. A method of disrupting tornadic activity by preventing or reducing an electrical connection of the electrical helical coil of an impending storm or creating an electrical disconnect in an existing storm through any available means, where rotation is maintained by electromagnetic forces and the consumption of conductive materials (i.e. charged particles) in the area within or surrounding the tornado at different altitudes, comprising the steps of:
a. Locating an area conducive to or containing ongoing tornadic activity; wherein the area comprises a storm, including mesocyclones that contains the appropriate environmental conditions for the formation of a tornado,
b. Releasing a chemical agent into the area ahead of the storm and/or tornado,
c. Wherein the chemical agent is released at the altitude of cloud formation ahead of the storm,
d. And wherein the chemical agent is contained in a container and is released from the container by dispersion into the atmosphere by hose, pipe or other dispersion method
e. And wherein the chemical agent is delivered to the area ahead of the storm and/or tornado by airplane or remotely piloted drone,
Wherein the area of possible or ongoing tornadic activity is comprising of:
a storm, including mesocyclones, that contains the appropriate level of environmental conditions for tornado formation,
wherein releasing a chemical agent into the area ahead of the storm and/or tornado,
wherein the chemical agent is released at the altitude of cloud formation ahead of the storm,
f. And wherein the chemical agent is contained in a container and the container is released from the airplane or remotely piloted drone to be detonated remotely ahead of the tornado.

5. The method of combining claims 1, 2, 3 and 4 to disrupt tornado activity.
